(19) United States
(12) Patent Application Publication
(10) Pub. No.: US 2012/0068815 A1
(43) Pub. Date: Mar. 22, 2012

(54) System and Method for Automatically Updating, Backing Up or Restoring Access Control Systems

(75) Inventors: John A. Dziadosz, Burlington, WI (US); Jeffrey S. Zingsheim, Franklin, WI (US)

(73) Assignee: Honeywell International Inc., Morristown, NJ (US)

(21) Appl. No.: 12/886,798

(22) Filed: Sep. 21, 2010

(51) Int. Cl. G06F 7/04

(52) U.S. Cl. 340/5.7

(57) ABSTRACT

An access control panel can be updated substantially automatically by loading a thumb drive with executable instructions, or information, and coupling the drive to the panel and transferring the instructions or information to the panel for execution or storage. Alternately, the coupling can be implemented via a computer network.

### FIELD

The invention pertains to access control systems. More particularly, the method pertains to such systems and methods which can be updated, backed up or restored substantially automatically.

### BACKGROUND

Access control systems find use in a wide variety of environments and applications where it is necessary to control access to one or more regions via one or more lockable doors. An installation might include just a single access control panel. Alternately, there might be a loop of interconnected access control panels.

Such panels usually include at least one programmable processor, executable instructions stored on a computer readable medium. They might also include a data storage device, which might be a solid state memory unit for storage of data or a database.

Such systems at times need to be updated, backed up or restored depending on the circumstances. Various approaches are known. These include, Dziadosz published US Patent Application No. 2009/0080443 entitled System and Method for Remotely Administering and Synchronizing A clustered Group of Access Control Panels, published Mar. 26, 2009, assigned to the assignee hereof and incorporated by reference. Dziadosz published US Patent Application No. 2009/0121830 entitled Employing External Storage Devices as Media for Access Control Panel Control Information, published May 14, 2009, assigned to the assignee hereof and incorporated by reference. Zingsheim published US Patent Application No. 2009/0106116 entitled Updating Dynamic Information Within An Intelligent Controller Utilizing A Smart Card, published Apr. 23, 2009, assigned to the assignee hereof and incorporated by reference. And, Zingsheim published US Patent Application No. 2009/0121831 entitled Dynamic Reprogramming of an Intelligent Controller Utilizing A Smart Card, assigned to the assignee hereof and incorporated by reference.

Notwithstanding the above, there continues to be a need for systems and methods to automatically update door access control systems.

### BRIEF DESCRIPTION OF THE DRAWINGS

FIG. 1 is a block diagram illustrating aspects of the invention; and

FIG. 2 is another block diagram illustrating different aspects of the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect of the invention, a specially formatted storage device such as a USB, or, thumb drive can be connected to an access control panel via a USB port. The device is automatically detected, and read. Its pre-programmed purpose and function are discerned from the device and are executed by the panel. These functions may include (but are not limited to) firmware update, database backup or restore, report generation or running diagnostics and capturing diagnostic information. In another aspect of the invention, executable commands can be downloaded to a panel via a computer network and implemented.

In another aspect of the invention, methods are provided for enabling a single access control panel or a loop of interconnected access control panels to be updated, backed up or restored automatically from a USB connected memory device or through a device connected via communication medium such as Internet or Intranet connection. The methods provide an attractive set of features which distinguish the invention from the prior art. The methods may also be integrated into a system of services that could be offered and sold for recurring revenue. The methods may be deployed and used to reduce “total installed cost” that an installer or end user incurs for maintenance functions.

For control panels that have USB or Ethernet ports, methods which embody the invention provide automatic detection of a network or USB connected service device, and the intended purpose of the service device. If the service device information is encrypted, will decrypt the service device information using an encryption key previously set by the panel administrator and securely stored on the panel. The panel's administrative password can be the default password for this purpose.

The intended purpose of the service device, along with the instructions to perform the service, (this information is stored on the device) can be automatically recognized by the respective door control panel. Exemplary services include, without limitation:
a. Perform diagnostic tests generate a report to the service device.
b. Upgrade to new firmware release.
c. Install individual feature updates.
d. Backup Configuration Data.
e. Restore Configuration Data.
f. Modify specific Configuration
g. Generate an Event Report to the service device.

In further embodiments of the invention, a USB and Ethernet service device can be used together. For example, events, reports or data could be cached on a USB device, then periodically sent to an external (Ethernet) connected service device for permanent storage.

Further, a USB type service device can be formatted to implement the processes described above. A GUI can be provided to enable a user to customize any of the above.

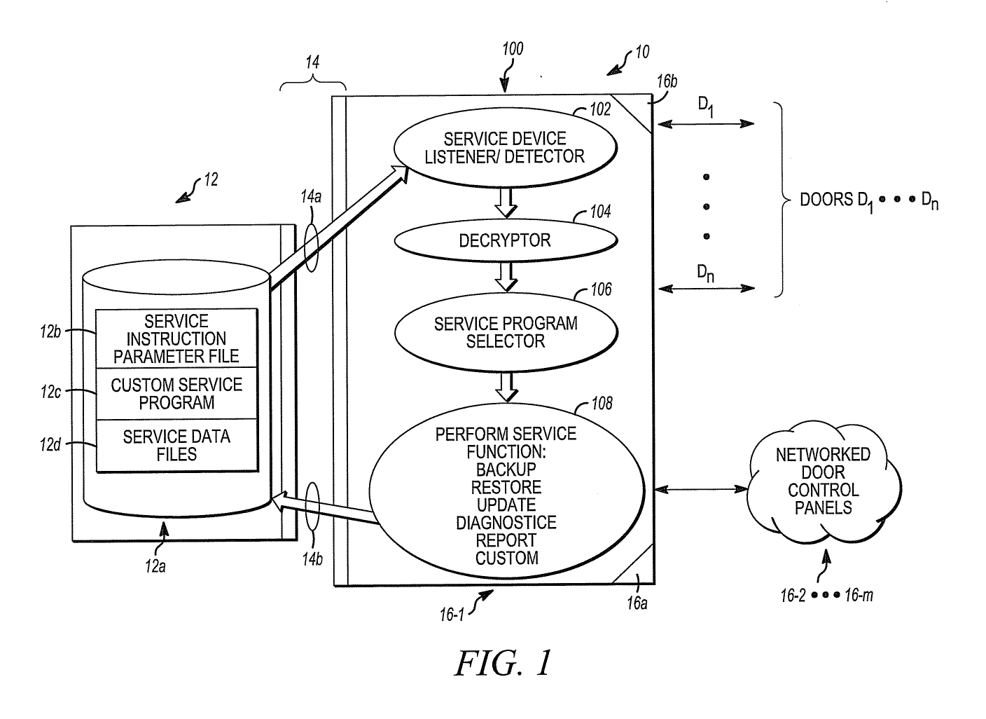

A system 10 which embodies the invention is illustrated in FIG. 1. A service device 12 is coupled via an interface 14 to at least one door access control panel 16-1. Panel 16-1 can be one of a plurality of networked door control panels, such as 16-2 . . . 16-m. Panel 16-1 is coupled to and controls a plurality of doors D1 . . . Dn.

Device 12 includes a storage unit 12a for instructions to an access control panel, such as 16-1, for performing specified service functions. An Instruction Parameter File 12b provides information to the panel 16-1 as to the type of service function to run. The input parameters required to perform the function can be included. For example, if the service type is a backup, parameters could include which database(s) of the unit 16-1, or other networked door control panels 16-2 . . . 16-n are to be backed up.

Custom service programs, such as 12c, can be included in storage unit 12a to override or supplement built-in servicer functions at the panel 16-1. Service data files 12d can be included in the device 12 to provide data to be used by the service function, or where the service function returns data such could be stored in the files 12d for subsequent analysis and examination.

Interface 14 can be implemented, without limitation as a USB-type interface, or can be implemented as a networked interface via a computer network as would be understood by those of skill in the art. Where the interface 14 is a USB-type interface, the unit 12 would be attached to the panel 16-1. In either embodiment, instructions and information can be transferred to the panel 16-1 as indicated generally at 14a to implement the defined process(s).

Panel 16-1, as well as 16-2 . . . 16-m can include a programmable processor 16a, and associated pre-stored executable instructions 16b which can detect, via 14a of interface 14, a network or USB connected service device, such as device 12, as at 102, and will carry out a decryption process, as at 104 as needed. Subsequently, the required service to be carried out can be determined as at 106, and then implemented, as at 108. Diagnostic results, reports and the like can be reported via 14b to the device 12 for analysis.

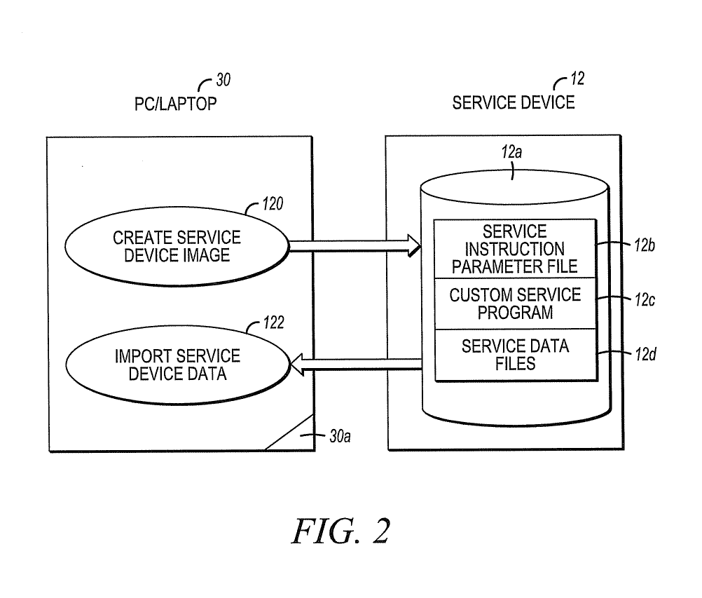

FIG. 2 illustrates interaction between device 12 and an associated computer 30 executing instructions 30a. Device 12 can communicate with computer 30 via an interface, generally indicated at 32 which can be implemented via a USB-type port, or any other type of coupling without limitation. Instructions 30a can implement a program with a graphical user interface that enables a user to encode the service device 12 for one or more of the following all without limitation:
1. Update one or multiple panels on loop,
2. Backup part or all the data on an access control panel or loop.
3. Restore a previously saved database.
4. Perform diagnostic tests on the panel and return results.
5. Generate information required for various reports. E.G, database, events.

In accordance with the above, the service device file(s) can be created via computer 30, as at 120, transferred to the device 12. The device 12 can in turn communicate with the respective door control panel 16-1 . . . 16-m, obtain feedback files 12d and provide that data, as at 122 to the computer 30 for analysis.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
providing a device with a storage unit and a USB-type input/output interface;
loading a part of the storage unit with at least one of executable instructions or data;
coupling the storage unit to at least one access control panel via the interface;
transferring at least one of executable instructions or data to the coupled panel; and
carrying out at the panel at least one function in response to the transferring.

2. A method as in claim 1 where the function is selected from a group which includes at least door control instruction updating, database updating, database restoring, report generation, executing diagnostics or capturing diagnostic information.

3. A method as in claim 1 where coupling includes connecting the storage unit to the access control panel.

4. A method as in claim 3 where connecting includes providing a USB-type port at the access control panel.

5. A method as in claim 3 which includes creating a file of at least one of executable instructions or data.

6. A method as in claim 5 which includes coupling the storage unit to a programmable processor and then includes creating the file of at least one of executable instructions or data.

7. A method as in claim 6 which includes subsequently coupling the unit loaded with the file to the access control panel.

8. An apparatus comprising:
an access control unit having at least one input/output port;
circuitry which includes a storage device where the storage device carries a plurality of pre-stored instructions; and
is coupled to the input/output port with circuitry to transfer the pre-stored instructions to the access control unit for execution.

9. An apparatus as in claim 8 where circuitry and storage device are included in a thumb drive.

10. An apparatus as in claim 9 which is coupled via a USB-type input/output port.

11. An apparatus as in claim 8 which is coupled via a computer network.

12. An apparatus comprising:
a storage unit that includes a computer readable storage device; and
an input/output port coupled to the device where the device carries pre-stored instructions to update at least one access control panel.

13. An apparatus as in claim 12 coupled to the access control panel where the panel includes a programmable processor and executable instructions that communicate with the instructions from the storage device.

14. An apparatus as in claim 13 where the storage device includes a data set which, responsive to the pre-stored instructions, downloads the data set to the programmable processor to store at the panel.

15. An apparatus as in claim 14 where the programmable processor includes instructions to store the data set.

16. An apparatus as in claim 15 where the programmable processor includes circuitry to carry out a function selected from a group which includes instruction updating, database updating, database restoring, report generation, executing diagnostics or capturing diagnostic information.

17. An apparatus as in claim 16 which includes a second, different programmable processor to produce a file to be loaded into the storage unit.
